(19) United States
(12) Patent Application Publication
(10) Pub. No.: US 2019/0342405 A1
(43) Pub. Date: Nov. 7, 2019

(54) USAGE-BASED INTELLIGENT LOADING OF COMPONENTS IN A COMPONENT-DRIVEN, MULTI-TENANT CLOUD APPLICATION

(71) Applicant: salesforce.com, inc., San Francisco, CA (US)

(72) Inventor: Ashraya Raj MATHUR, Livermore, CA (US)

(21) Appl. No.: 15/971,923

(22) Filed: May 4, 2018

(51) Int. Cl. H04L 29/08; H04L 29/06

(52) U.S. Cl. CPC H04L 67/22; H04L 67/32; H04L 67/10; H04L 67/42

(57) ABSTRACT

A method for dynamically configuring a web page of an application, including a set of components presented in the web page, is described. The method includes determining, by a web server, usage characteristics associated with a user and the set of components of the web page; modifying, by the web server, an optimization parameter for a component in the set of components based on the usage characteristics, wherein the optimization parameter for the component indicates that a minimized version of the component is to be used in the web page for the user instead of a full-sized version of the component; and generating, by the web server based on the optimization parameter for the component, the web page such that the minimized version of the component is used in the web page.

### TECHNICAL FIELD

One or more implementations relate to the field of web page management in a component-driven, multi-tenant cloud application; and more specifically, to intelligently loading components in a web page based on user usage characteristics and/or performance metrics.

### BACKGROUND

A cloud-based application may be defined by one or more web pages and each web page may be composed of multiple components. Each component in a web page may include multiple user interface elements (e.g., texts boxes, buttons, labels, etc.) and may request information from a web server using server actions/requests. For example, a web page may include a news feed component, which lists links and/or headlines of news articles; a weather component, which displays weather conditions at a location; and an email preview component, which displays a brief synopsis of email messages received at an email account (e.g., subject line, time received, etc.). Once loaded on a client device of a user, the news feed component may request relevant news articles from a web server, the weather component may request weather information at the location from the web server, and the email preview component may request email message information from the web server. The requests corresponding to each component may be combined into a single request that is transmitted to the web server (i.e., a batch request). In response, the web server may transmit data describing news articles to be presented to the user via the news feed component, weather information to be displayed to the user via the weather component, and email message information to be displayed to the user via the email preview component.

The above described web page may include a considerable amount of network and processing resources, both at the client device and the web server, to fully load and maintain data in the web page up-to-date. However, although information in each component of the web page (e.g., the news feed component, the weather component, and the email preview component) are presented to the user, the user may often only consume/view certain portions of the data. For example, the user may be interested in news articles presented by the news feed component and email messages presented by the email preview component, but rarely views or otherwise consumes weather information presented by the weather component. Accordingly, network and processing resources devoted to loading the web page are being inefficiently utilized, as some of the information (e.g., the weather information) is typically not consumed/viewed by the user.

### BRIEF DESCRIPTION OF THE DRAWINGS

The following figures use like reference numbers to refer to like elements. Although the following figures depict various exemplary implementations, alternative implementations are within the spirit and scope of the appended claims. In the drawings:

FIG. 1 shows a block diagram illustrating a computing environment, including a web server, according to one example implementation.

FIG. 2 shows a method for dynamically configuring a web page, including one or more components presented in the web page, according to one example implementation.

FIG. 3 shows a web page presented to a user via a display of a client device, according to one example implementation.

FIG. 4A shows a configuration for the web page, including a set of components, according to one example implementation.

FIG. 4B shows a configuration for the web page with optimization parameters for each component, according to one example implementation.

FIG. 5 shows an expanded version of a call logging component, according to one example implementation.

FIG. 6 shows a minimized version of the call logging component, according to one example implementation.

FIG. 7 shows a set of analytic metrics, according to one example implementation.

FIG. 8A illustrates an electronic device according to one example implementation.

FIG. 8B shows a block diagram of an environment where the computing environment and the web server may be implemented according to one example implementation.

### DETAILED DESCRIPTION

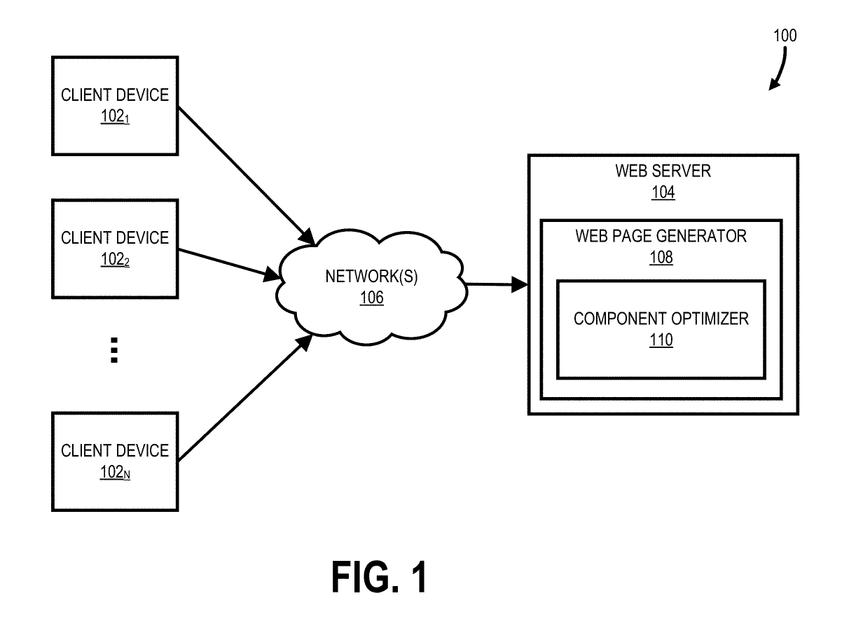

FIG. 1 is a block diagram illustrating a computing environment 100, according to one example implementation. The computing environment 100 includes client devices 102₁-102_{N} (where N>2), a web server 104, and a set of networks 106. The computing environment 100 provides information to users operating the client devices 102₁-102_{N} via component-based applications. In particular, the client devices 102₁-102_{N} present components in component-driven, cloud applications to users via one or more web pages. The components may include/present various pieces of information that are received from the web server 104 based on corresponding requests from the components of the web pages. For example, a web page presented on the client device 1021 (e.g., in a web browser operating on the client device 1021) may include a news feed component, which lists links and/or headlines of news articles; a weather component, which displays weather conditions at a location; and an email preview component, which displays a brief synopsis of email messages received at an email account (e.g., subject line, time received, etc.). As will be described in greater detail below, the web server 104 may intelligently configure components of the web page via the web page generator 108 and component optimizer 110 based on (1) usage characteristics of the user of the client device 102₁ in relation to each component on the web page and (2) performance metrics associated with each web page (e.g., client device metrics for loading the web page on the client device 1021, network metrics for fulfilling data requests for components in the web page over the network 106, and web server metrics for generating/serving the web page by the web server 104) to efficiently utilize network and processing resources.

For example, web page generator 108 of the web server 104 may intelligently generate a web page to include components based on engagement by the user with the components in the web page as determined by the component optimizer 110. This engagement may be determined by the component optimizer 110 based on the usage characteristics, including one or more of historic click/selection interactions within the web page, historic click paths within the web page, and time spent on the web page. Based on the above usage characteristics, the web server 104 may determine that the user of the client device 102₁ rarely focuses or otherwise consumes weather information provided by the weather component of the web page (i.e., the user has a historic low engagement with the weather component, including few clicks in the weather component, few click paths through the weather component, etc.). As a result of this determination of low use/focus/engagement with the weather component, the web server 104 may determine to include a minimized version of the weather component in the web page instead of a default/expanded/full-sized version of the weather component. As noted above, in some implementations, performance metrics associated with each web page (e.g., client device metrics for loading the web page on the client device 1021, network metrics for fulfilling data requests for components in the web page over the network 106, and web server metrics for generating/serving the web page by the web server 104) may be determined by the component optimizer 110 used by the web page generator 108 of the web server 104 for intelligently generating the web page. In these implementations, the web server 104 may also determine that loading a minimized version of the weather component would provide a noticeable or significant decrease in resource consumption (e.g., decrease in consumption of client device 1021 processing resources, network 106 resources, and/or web server 104 processing resources). In response to determining low use/focus/engagement by the user with the weather component and a benefit in using a minimized weather component in comparison to a default/expanded/full-sized weather component, the web server 104 may generate a configuration for the web page that references the minimized version of the weather component instead of the full-sized version of the weather component. This minimized version of the weather component includes fewer display elements (e.g., text boxes, buttons, etc.) and/or less information (e.g., only the current temperature is presented in the weather component instead of the current temperature and tomorrow's forecast temperature) in comparison to the full-sized version of the weather component. In some implementations, the minimized version of the weather component may be expanded/replaced with the full-sized version of the weather component while the web page is in use by the user (e.g., after the user clicks on the minimized weather component). Providing a minimized version of the weather component instead of a full-sized version of the weather component reduces the amount of client device 1021 processing resources, network 106 resources, and/or web server 104 processing resources required to load the web page. Further, since the determination to provide the minimized version of the weather component is based, at least partly, on user usage characteristics, the user will not be overly impacted by this modification to the web page. In particular, since the determination to load a minimized version of the weather component is at least partly based on low user engagement for the weather component, the user will not likely be impacted by the reduced footprint of the weather component on the web page. Accordingly, as will be described in greater detail below, the web server 104 may provide a more efficient delivery of the web page without materially altering user experience.

Although described in relation to specific types of web components (e.g., a weather component, a news feed component, etc.), the techniques described herein may be extended to any type of web component. Accordingly, the use of specific types of components is for illustrative purposes rather than limitation. Further, although described in relation to optimization of a single component in a web page (e.g., using a minimized version of a weather component instead of a full-sized version of the weather component), the techniques described herein may be applied to multiple components in a web page. Accordingly, minimized versions of multiple components may be determined to be used in a single web page based on user usage characteristics and/or performance metrics as will be described in greater detail below.

Each element of the computing environment 100 of FIG. 1 will now be described in greater detail below by way of example. In some implementations, the computing environment 100 may include more elements than those shown in FIG. 1. Accordingly, the computing environment 100 of FIG. 1 is purely for illustrative purposes.

As shown in FIG. 1 and described above, the client devices 102₁-102_{N} and the web server 104 may be connected through a set of one or more networks 106. The set of networks 106 may be, for example, a local area network (LAN), a wide area network (WAN), a global area network (GAN), such as the Internet, or a combination of such networks. In another implementation, the client devices 102₁-102_{N} and the web server 104 may maintain a direct connection to each other via a wired or wireless medium.

Each of the client devices 102₁-102_{N} may be a computing system that may be operated by one or more users. For example, each of the client devices 102₁-102_{N} may be a personal computer (PC), a workstation, a laptop computer, a tablet computer, a mobile phone, a smartphone, a personal digital assistant (PDA), or the like. As will be described in greater detail below, the client devices 102₁-102_{N} may communicate with the web server 104 to access resources, such as one or more applications operating on or served by the web server 104. The applications may include or may be defined by a set of web pages that each includes a set of components (e.g., a news feed component, a weather component, etc.) and each component may include one or more display elements (e.g., list boxes, text fields, dropdown buttons, radio buttons, etc.). The client devices 102₁-102_{N} may each include a screen/display (e.g., a liquid crystal (LCD) display) for presenting web pages, including each component of the web pages, to the user via a web browser.

The client devices 102₁-102_{N} may each be associated with one or more organizations/tenants. For example, users of the client devices 1021 and 102₂ may be customers of a first organization/tenant and a user of the client device 102_{N} may be a customer of a second organization/tenant. Organizations/tenants may be any firm, corporation, institution, association, or society that has contracted with an administrator of the web server 104 to provide users access to the organization's/tenant's applications, including associated web pages, via the client devices 102₁-102_{N}. Accordingly, the web server 104 may provide web pages from multiple tenants to various client devices 102₁-102_{N}.

In one implementation, the web server 104 may be any computing device that provides users access to resources via the client devices 102₁-102_{N} and the network 106. For example, the web server 104 may be a multi-tenant server that provides users of the client devices 102₁-102_{N} access to one or more applications. The applications (sometimes referred to as client applications or web applications) and other resources provided by the web server 104 (e.g., processing resources, storage resources, etc.) may be maintained and managed by the web server 104 and made available to users of client devices 102₁-102_{N} as needed (i.e., “on-demand”). For instance, upon a user of a client device 102₁-102_{N} requesting a web page of an application served by the web server 104 via a web browser (e.g., the user entering a uniform resource locator (URL) into an address bar of the web browser), the requesting client device 102₁-102_{N} may transmit a request for the web page to the web server 104 using the network 106. The request may include sub-requests, or the request may otherwise be a batch request, for information from each component of the web page. In response, the web server 104 may generate a configuration that describes the web page, including each component of the web page, and the web server 104 may use this configuration to generate a set of files that represents the web page (e.g., a set of Hypertext Markup Language (HTML) files). The set of files representing the web page may be thereafter transmitted to the requesting client device 102₁-102_{N} via the network 106.

The web server 104 may include various elements of hardware and software of a multi-tenant system. As used herein, the term “multi-tenant system” refers to those systems in which various elements of hardware and software may be shared by one or more tenants. For example, the web server 104 may simultaneously process requests for a great number of tenants, and a given database table may store records for a potentially much greater number of tenants. The web server 104 may include an application platform including a framework that allows applications to execute, such as the hardware or software infrastructure of the system. In one implementation, the application platform enables the creation, management, and execution of one or more applications developed by the provider of the web server 104, users accessing the web server 104 via client devices 102₁-102_{N}, or third-party application developers.

In some implementations, the web server 104 may include or may have access to a database or another repository of components. The components may be used across web pages, applications, and/or tenants or may be specific for a particular web page, applications, and/or tenant. For example, a first tenant may design a first component that is used exclusively for web pages and applications associated with the first tenant while a second tenant may design a second component that may be used by web pages and applications of other tenants, including the first tenant. Both the first component and the second component may be stored in the database of components such that the web server 104 may have access to these components when configuring and generating a web page. In some implementations, the database of components may include different versions of a single component. For example, the database of components may include a default/expanded/full-sized version of a component and a minimized version of the component, which includes fewer display elements (e.g., text boxes, buttons, etc.) and/or presents less information than the default/expanded/full-sized counterpart.

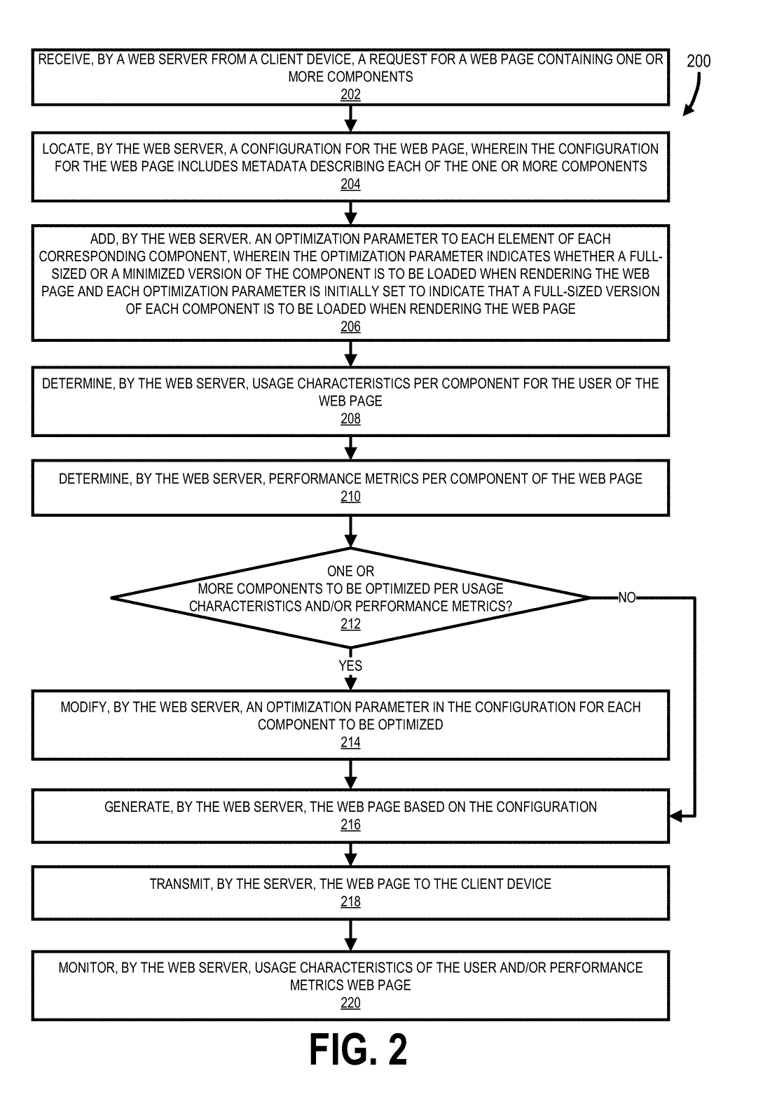

Turning now to FIG. 2, a method 200 according to one implementation will be described for dynamically configuring a web page, including one or more components presented in the web page. In particular, the web server 104 may determine, based at least partly on usage characteristics of the user and/or performance metrics associated with a client device 102₁-102_{N}, the web server 104, and/or the network 106, to present a minimized version of a component in the web page in place of a full-sized version of the component. The operations in the flow diagram of FIG. 2 will be described with reference to the exemplary implementations of the other figures. However, it should be understood that the operations of the flow diagram can be performed by implementations other than those discussed with reference to the other figures, and the implementations discussed with reference to these other figures can perform operations different than those discussed with reference to the flow diagrams.

Although described and shown in FIG. 2 in a particular order, the operations of the method 200 are not restricted to this order. For example, one or more of the operations of the method 200 may be performed in a different order or in partially or fully overlapping time periods. Accordingly, the description and depiction of the method 200 is for illustrative purposes and is not intended to restrict to a particular implementation.

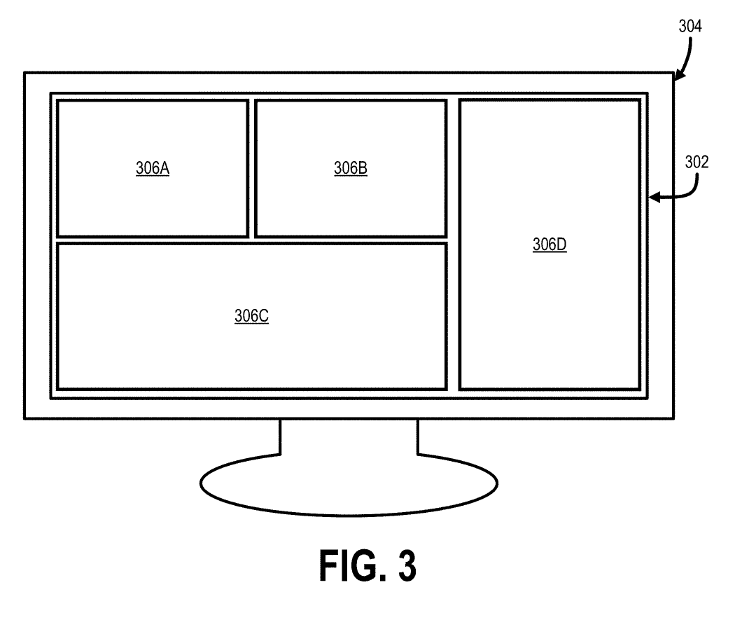

As shown in FIG. 2, the method 200 may commence at operation 202 with the web server 104 receiving a request for a web page containing one or more components. In one implementation, the request may be received from the client device 1021 via the network 106. FIG. 3 shows an example, according to one implementation, of a web page 302 presented on a display 304 of the client device 1021. As shown in FIG. 3, the web page 302 includes the components 306A-306D. The components 306A-306D may be or may include display elements, including one or more of texts boxes, buttons, drop down menus, and labels. For example, the component 306A may be a call logging component that allows a user to record and/or lookup phone calls, the component 306B may be a news feed component that presents news articles to the user (e.g., parts/snippets of the news articles, including links, synopses, or sentences from the full news articles), the component 306C may be a weather component that displays weather conditions at a location to the user, and the component 306D may be an email preview component that displays a brief synopsis of email messages received at an email account (e.g., subject line, time received, etc.) to the user. The web page 302, including the components 306A-306D, will be used during the remainder of the description of the method 200. However, the method 200 may be used in conjunction with any component-based web page and corresponding application. Thus, the use of the web page 302 and corresponding components 306A-306D is illustrative and is not intended to limit the use of the method 200.

In one implementation, the client device 1021 may batch requests together into a batch request that is received by the web server 104 at operation 202. For example, requests for data from each of the components 306A-306D may be batched together using an Extensible Markup Language (XML) Hypertext Transfer Protocol (HTTP) Request (XHR) or another similar data structure and/or protocol. The web page 302 and corresponding application may utilize multiple XHRs to deliver/present information in each of the components 306A-306D to the user of the client device 102₁ (i.e., deliver a page view of the web page 302 to the user of the client device 102₁).

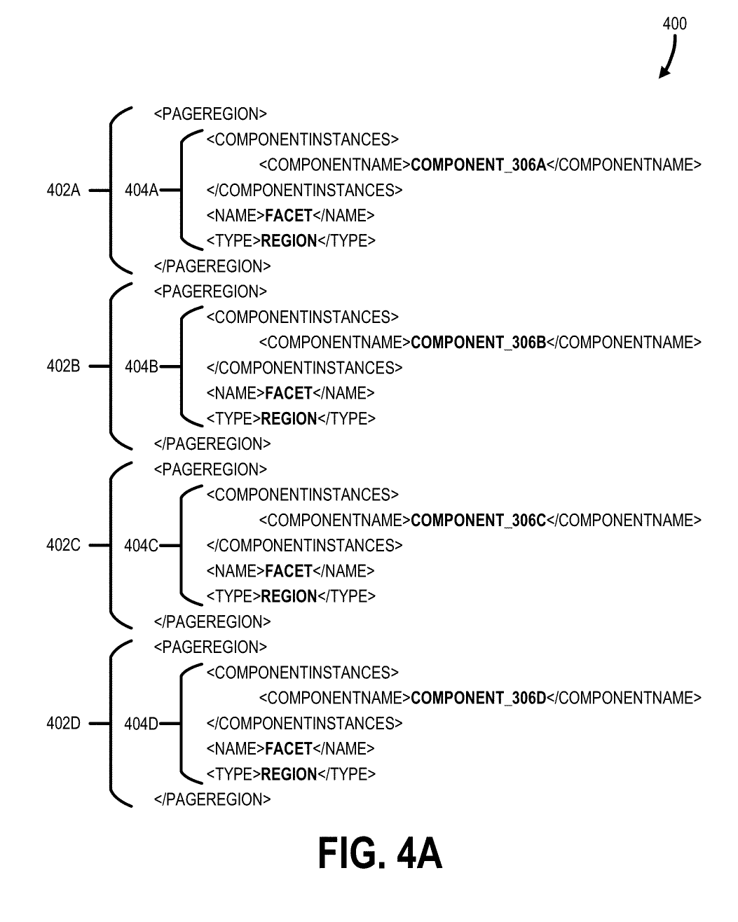

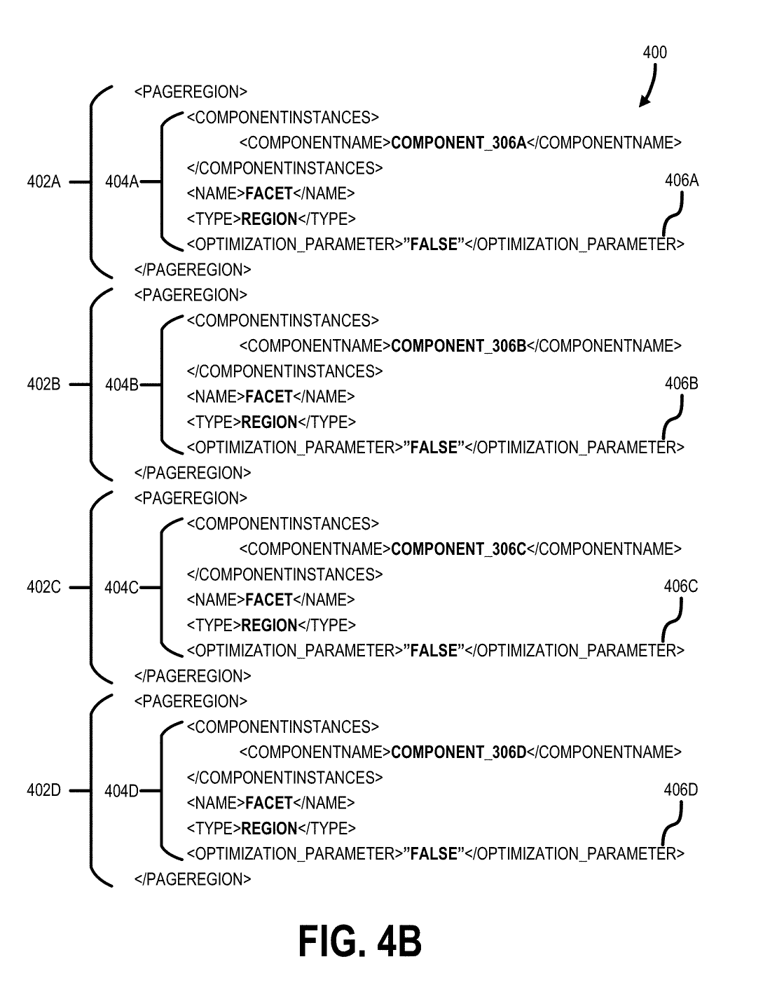

At operation 204, the web server 104, and in particular the web page generator 108, may locate a configuration for the web page 302 corresponding to the request from operation 202. The configuration identifies the components 306A-306D in corresponding regions of the web page 302 and provides metadata for use in generating and rendering the web page 302. FIG. 4A shows an example configuration 400 that may be located at operation 204. As shown, the configuration 400 separates each component 306A-306D into separate region 402A-402D and provides metadata 404A-404D for each region 402A-402D and corresponding component 306A-306D. For example, the region 402A and metadata 404A corresponds to the component 306A, the region 402B and metadata 404B corresponds to the component 306B, the region 402C and metadata 404C corresponds to the component 306C, and the region 402D and metadata 404D corresponds to the component 306D. The metadata 404A-404D describes each corresponding component 306A-306D. For example, the metadata 404A-404D includes the name for each component 306A-306D. As shown, the configuration 400 is defined/represented using Extensible Markup Language (XML). However, in other implementations, the configuration 400 may be defined/represented using any language or encoding scheme. The example configuration 400 will be used to further explain the method 200; however, the use of the example configuration 400 of FIG. 4 is purely for illustrative purposes and does not limit configurations that may be used by the method 200.

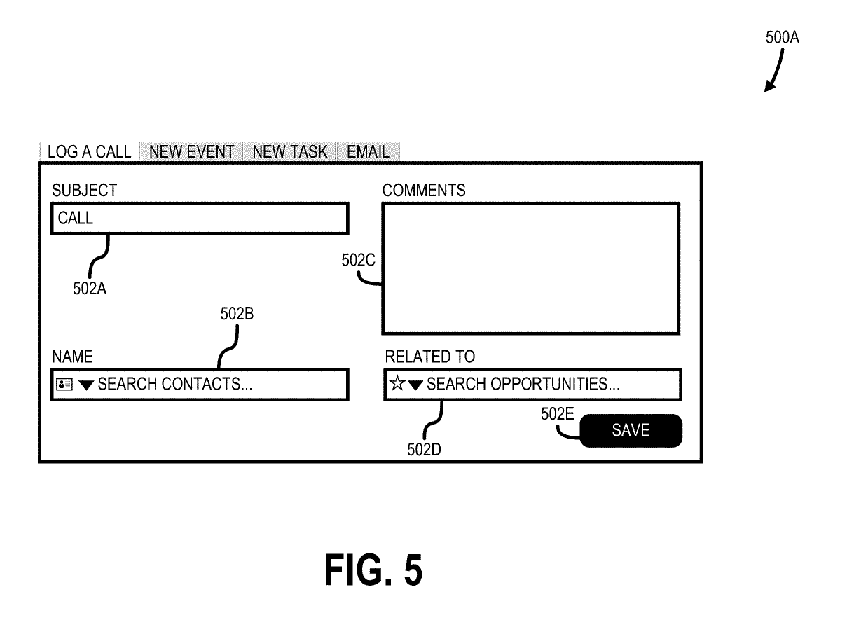

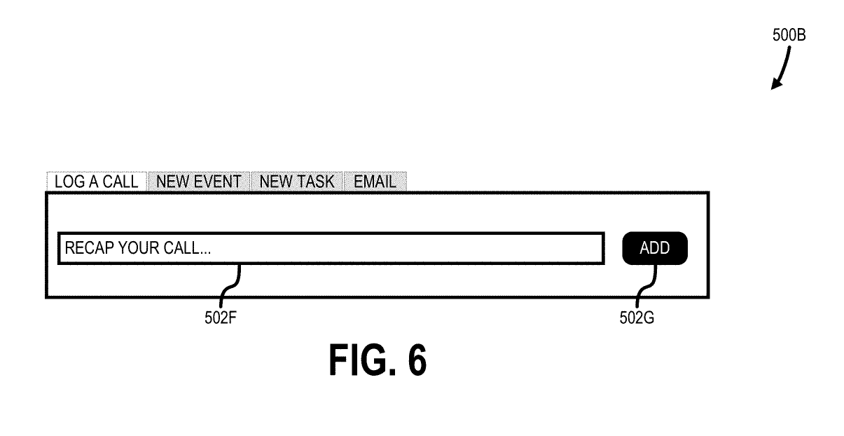

At operation 206, the web server 104, and in particular the component optimizer 110 of the web page generator 108, may add an optimization parameter to the configuration 400 for each region 402A-402D corresponding to the components 306A-306D. For example, as shown in FIG. 4B, the optimization parameters 406A-406D may be added to the metadata 404A-404D for each region 402A-402D. The optimization parameters 406A-406D indicate whether a full-sized/expanded or minimized version of each component 306A-306D is to be used when generating the web page 302. As used herein, a minimized version of a component 306A-306D includes fewer display elements and/or presents less information than a full-sized version of the component 306A-306D. For example, FIG. 5 shows an expanded version 500A of component 306A, which in this example is a call logging component, and FIG. 6 shows a minimized version 500B of the component 306A. As will be described herein, one version of the component 306A (i.e., either the full-sized version or the minimized version) will be included in the web page 302 that will be transmitted to the client device 1021 for presentation to the user. In the examples shown in FIG. 5 and FIG. 6, the full-sized version 500A of the component 306A includes more display elements and/or presents more information than the minimized version 500B of the component 306. In particular, in the examples shown in FIG. 5 and FIG. 6, the full-sized version 500A of the component 306A includes five display elements 502A-502E, while the minimized version 500B of the component 306A includes two display elements 502F and 502G. Accordingly, the full-sized version 500A of the component 306A includes fewer display elements 502 than the minimized version 500B of the component 306A and would require less client device 102₁ processing resources, web server 104 processing resources, and/or network 106 resources to generate, deliver, and load the web page 302. Thus, as will be described in greater detail below, in cases where optimization is determined to be desirable or acceptable for a component 306A-306D (e.g., lower user engagement with the component 306A and/or a large reduction in consumption of resources by using the minimized version 500B of the component 306A in comparison to the full-sized version 500A of the component 306A), the minimized version 500B of the component 306A may be used in place of the full-sized version 500A of the component 306A to reduce consumption of processing and networking resources. In comparison, were optimization is not determined to be desirable or is determined to be unacceptable for a component 306A-306D (e.g., high user engagement with the component 306A and/or a small reduction in consumption of resources by using the minimized version 500B of the component 306A in comparison to the full-sized version 500A of the component 306A), the full-sized version 500A of the component 306A may be used in place of the minimized version 500B of the component 306A for the web page 302. Although described in relation to the component 306A, full-sized/expanded and minimized versions may be determined/constructed for each of the components 306A-306D such that either version of the components 306A-306D may be used when generating and loading the web page 302.

In one implementation, each optimization parameter 406A-406D added to the configuration 400 at operation 206 may be set/defaulted at operation 206 to indicate that a full-sized version of the corresponding component 306A-306D is to be used when generating and loading the web page 302. For example, the optimization parameters 406A-406D for each component 306A-306D in the example configuration 400 of FIG. 4B may have a value of “false”. These “false” values indicate that optimization of the components 306A-306D should not be undertaken and the full-sized version of the corresponding component 306A-306D is to be used when generating and loading the web page 302. For instance, when the optimization parameter 406A for the component 306A is not toggled (e.g., the optimization parameter 406A for the component 306A has a value of “false”), the full-sized version 500A of the call logging component 306A is used to generate the web page 302 by the web server 104 and to load the web page 302 by the client device 1021 instead of the minimized version 500B of the call logging component 306A.

At operation 208, the web server 104, and in particular the component optimizer 110 of the web page generator 108, may determine usage characteristics for the user of the web page 302. The usage characteristics may include one or more of (1) click interactions by the user in the web page 302, (2) click paths by the user in the web page 302, and (3) time spent by the user on the web page 302. As used herein, click interactions are clicks/selections by the user in the web page 302 during a session using a pointer or another virtual selection tool. For example, a user of the web page 302 may use a mouse, trackpad, or another selection device of the client device 102₁ to click one or more components 306A-306D in the web page 302. Each click interaction determined at operation 208 may include the context of the interaction (e.g., the component 306A-306D clicked, the display element 502 within the component 306-306D clicked, the time of the click, and the action performed after the click (e.g., enter data to log a call)).

As used herein, a click path is the sequence/path of clicks or actions by a user through the web page 302 during a session. For example, a user of the web page 302 may use a mouse, trackpad, or another similar device of the client device 1021 to move a virtual pointer through the web page 302. The path through the web page 302 taken by the virtual pointer is a click path. Each click path determined at operation 208 may include the context of the click path (e.g., the components 306A-306D traversed and timing information associated with the click path).

These click interactions, click paths, and/or time spent on the web page 302 may be recorded and stored for each session in which the user is interacting with the web page 302 (e.g., between the user logging into the web page 302 (or a corresponding application) and the user logging out of the web page 302 (or a corresponding application)). For example, the client device 1021 may capture/record click interactions, click paths, and time spent on the web page 302 and report this information (at completion of a session or in a batch after completion of multiple sessions) for storage on the web server 104 in a database or another storage structure. At operation 208, the web server 104 may query or otherwise retrieve these usage characteristics related to the user for the web page 302.

Although described in relation to the components 306A-306D for the web page 302, usage characteristics for the user may be recorded and stored for the components 306A-306D in any web page. In particular, one or more of the components 306A-306D may be used in another web page (provided by the same tenant or a different tenant). In this example, the usage characteristics determined at operation 208 may be relative to usage/interactions by the user in any web page irrespective of the associated application or tenant.

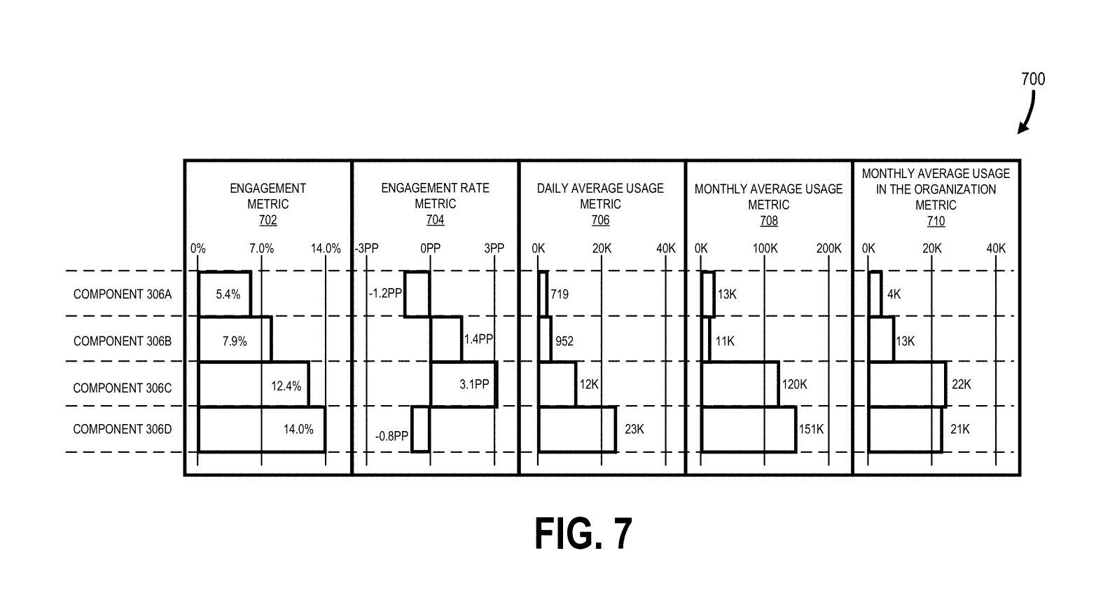

FIG. 7 shows a set of analytic metrics 700, which may be included in the usage characteristics that are determined at operation 208. In one implementation, the analytic metrics 700 are derived based on the preceding determined interactions by the user (e.g., click interactions, click paths, and time spent by the user on the web page 302). As shown in FIG. 7, an engagement metric 702 may be determined for a user relative to components 306A-306D on the web page 302. The engagement metric 702 indicates the percentage of time the user uses/engages with particular components 306A-306D in the web page 302. As shown, component 306A has the lowest level of usage/engagement by the user at 5.4%, while component 306B has the next lowest level of usage/engagement at 7.9%, followed by component 306C at 12.4%, and component 306D at 14.0%. The engagement metric 702 is taken across multiple sessions of the web page 302 over a prescribed time period (e.g., a day, a week, a month, a year, etc.). In some implementations, the engagement metric 702 is taken across multiple web pages, including the web page 302 (i.e., one or more of the components 306A-306D are used in multiple web pages, including the web page 302 such that the usage characteristics used to derive the analytic metrics 700 are computed for corresponding components 306A-306D across all web pages).

As also shown in FIG. 7, the analytic metrics 700 may include an engagement rate 704. The engagement rate 704 indicates the direction and rate at which a user is engaging with a corresponding component 306A-306D in the web page 302. The engagement rate 704 is taken across multiple sessions of the web page 302 over a prescribed time period (e.g., day, week, month, year, etc.). For example, as shown in FIG. 7, the user is decreasing use of component 306A by 1.2 percentage points (PP) over a prescribed time period (e.g., day, week, month, year, etc.). In contrast, the user is increasing use of component 306B by 1.4 PP over the prescribed time period. As noted above, in some implementation, the engagement rate 704 is taken across multiple web pages, including the web page 302 (i.e., the components 306A-306D are used in multiple web pages, including the web page 302).

The analytic metrics 700 may also include metrics across users and/or organizations for comparison purposes. For instance, in one implementation, the analytic metrics 700 may also include a daily active usage (DAU) metric 706 that indicates the average daily number of uses of each component 306A-306D by any user associated with the same organization/tenant as the current user. For example, as shown in FIG. 7, the DAU metric 706 for the component 306A is 719, the DAU metric 706 for the component 306B is 952, the DAU metric 706 for the component 306C is 12,000, and the DAU metric 706 for the component 306D is 23,000.

In one implementation, the analytic metrics 700 may also include a monthly active usage (MAU) metric 708 that indicates the average monthly number of uses of each component 306A-306D by any user associated with the same organization/tenant as the current user. For example, as shown in FIG. 7, the MAU metric 708 for the component 306A is 13,000, the MAU metric 708 for the component 306B is 11,000, the MAU metric 708 for the component 306C is 120,000, and the MAU metric 708 for the component 306D is 151,000.

Although the DAU metric 706 and the MAU metric 708 are calculated across organizations/tenants, in some implementations, the analytic metrics 700 may also include a monthly active usage in the organization (MAO) metric 710. The MAO metric 710 indicates the average monthly number of uses of each component 306A-306D by any user regardless of association with an organization. For example, as shown in FIG. 7, the MAO metric 710 for the component 306A in the same organization as the current user is 4,000, the MAO metric 710 for the component 306B in the same organization as the current user is 13,000, the MAO metric 710 for the component 306C in the same organization as the current user is 22,000, and the MAO metric 710 for the component 306D in the same organization as the current user is 21,000.

At operation 210, the web server 104, and in particular the component optimizer 110 of the web page generator 108, may determine performance metrics for the web page 302. In particular, each layer of the client application may be instrumented to capture performance characteristics per user (e.g., per client device 102), per web page, and/or per component of a web page. For example, the web page 302 may include or be associated with a client device layer, a network layer, and a web server layer such that client device metrics may be recorded for the client device layer, network metrics may be recorded for the network layer, and web server metrics may be recorded for the web server layer. In one implementation, the client device metrics include one or more of web browser processing time, Javascript execution time, component creation time, and component rendering time. Accordingly, the client device metrics may capture the time needed by a client device 102₁-102_{N} to load/present the web page 302 to the user after receiving all necessary information from the web server 104 via the network 106.

In one implementation, network metrics include network latency and request/response sizes for each request. As used herein, latency is the time from the source (e.g., a client device 102₁-102_{N} or the web server 104) sending a packet (e.g., a request or a response to a request) to the destination (e.g., the web server 104 or a client device 102₁-102N) and the destination receiving the packet. This time excludes processing time by either the source (e.g., time associated with the client device 102₁-102_{N} processing/generating the request) or the destination (e.g., time associated with the web server 104 analyzing the request and/or fulfilling the request).

In one implementation, web server metrics measure the total response time for the web server 104. For example, the time between the web server 104 receiving a request from a client device 102₁-102_{N} and the web server 104 transmitting a response to the request. In some implementations, the web server metrics may breakdown timing information per activity (e.g., per application programming interface (API) call or query). Although described as separate, in some implementations, performance metrics may be included in the usage characteristics and may be determined at operation 208 by the web server 104.

Based on the client device metrics, the network metrics, and the web server metrics, one or more additional performance metrics may be calculated/determined. For example, in some implementations, the performance metrics determined at operation 210 may include an experience page time (EPT) metric that measures the total time to load a web page as experienced by the user. The EPT metric may be defined as the time from user interaction (e.g., the user clicking on a link or submitting a request for the web page 302) to full loading of the web page 302 on the client device 102₁-102_{N} (e.g., until no further activity or input from the client device 102₁-102_{N}, the network 106, and the web server 104 in required). In some implementations, a browser processing time (BPT) metric may be determined at operation 210 that measures the total time spent by a web browser of a client device 102₁-102_{N} for the web page 302. In some implementations, a network processing time (NPT) metric may be determined at operation 210 that measures the total time spent by the network 106 for the web page 302. In some implementations, a sever processing time (SPT) metric may be determined at operation 210 that measures the total time spent by the web server 104 for the web page 302. In some implementations, the EPT metric is defined by some function of the BPT metric, the NPT metric, and the SPT metric. Each of the EPT metric, the BPT metric, the NPT metric, and the SPT metric may be derived per user and per session and may be stored in the web server 104 for retrieval at operation 210.

In one implementation, the performance metrics, including the EPT metric, the BPT metric, the NPT metric, and the SPT metric, may be calculated per component 306A-306D and/or versions of components 306A-306D. For example, EPT metrics, BPT metrics, NPT metrics, and SPT metrics for the web page 302 may be calculated when the full-sized/expanded version 500A of the component 306A is used in the web page 302 and alternatively when the minimized version 500B of the component 306A is used in the web page 302. Accordingly, comparisons in performance of the web page 302 may be performed when full-sized and minimized versions of components 306A-306D are utilized in the web page 302. This provides insight into the benefit (e.g., reduction in consumption of processing and network resources) when using minimized versions of one or more of the components 306A-306D in place of their full-sized counterparts.

Following determining usage characteristics and/or performance metrics, the web server 104, and in particular the component optimizer 110 of the web page generator 108, may determine at operation 212 if one or more components 306A-306B in the web page 302 may be optimized per the usage characteristics and/or the performance metrics. For example, the web server 104 may determine at operation 212 that component 306A is historically not being utilized by the user. For example, this determination at operation 212 may be based on the engagement metric 702, which was determined with other usage characteristics at operation 208. For instance, when the component 306A has an engagement metric 702 below a prescribed threshold or when the engagement metric 702 for the component 306A is lower than engagement metrics 702 for all other components 306B-306D in the web page 302, the web server 104 may determine at operation 212 that the component 306A can be optimized (e.g., the minimized version 500B of the call logging component 306A may be used in place of the full-sized version 500A of the call logging component 306A).

In some implementation, the engagement rate metric 704 may be also used to indicate that one or more components 306A-306D are not being utilized by the user. For example, since the engagement rate metric 704 for the component 306A indicates a declining rate of usage of the component 306A (i.e., the engagement rate metric 704 is negative for the component 306A), the web server 104 may determine at operation 212 that the component 306A can be optimized.

In some implementations, the performance metrics, which were determined at operation 210, may be used by the web server 104, and in particular the component optimizer 110 of the web page generator 108, at operation 212 to determine if one or more components 306A-306B in the web page 302 may be optimized. In particular, performance metrics determined for different versions of components 306A-306D (e.g., full-sized and minimized versions of components 306A-306D) may be useful in determining whether using a particular version of a component 306A-306B will result in lowered consumption of processing and/or network resources. For example, when the difference between one or more performance metrics associated with the full-sized version 500A of the component 306A and corresponding performance metrics associated with the minimized version 500B of the component 306A are above a set of thresholds, the web server 104 may determine that the component 306A should be optimized (i.e., the reduction in processing and/or network resources as indicated by the performance metrics is large enough to warrant use of the minimized version 500B of the component 306A instead of the full-sized version 500A of the component 306A).

In response to determining that one or more components should be optimized, the method 200 may move to operation 214. At operation 214, the web server 104, and in particular the component optimizer 110 of the web page generator 108, may modify optimization parameters 406 in the configuration 400 for each component 306A-306D identified at operation 212. For example, the optimization parameter 406 corresponding to the component 306A may be modified from “false” to “true” at operation 214. This modification to the configuration 400 indicates that the minimized version 500A of the component 306A should be used in place of the full-sized version 500B of the component 306A when generating the web page 302.

Following modification of the configuration 400 at operation 214 or determining at operation 212 that no components 306A-306D in the web page 302 should be optimized, the method 200 may move to operation 216. At operation 216, the web server 104, and in particular the web page generator 108, may generate the web page 302 based on the configuration 400. In particular, a set of HTML files may be generated at operation 216 to reference the components 306A-306D based on the configuration 400. For components with optimization parameters 406 indicating optimization (i.e., optimization parameters 406 set to “true”) a minimized version of the component 306A-306D is used in place of a full-sized version of the component 306A-306D. For example, when the optimization parameter 406A in the configuration 400 for the component 306A has a value of “true”, the minimized version 500B of the component 306A is used to generate the set of HTML files instead of the full-sized version 500A of the component 306A.

At operation 218, the web server 104 may transmit the web page 302, which was generated at operation 216, to the requesting client device 102₁. In particular, the set of HTML files generated at operation 216 may be transmitted to the requesting client device 1021 via the network 106 using any set of network protocols. Upon receipt of the web page 302, the client device 201₁ may load the web page 302 in a web browser of the client device 1021. In this fashion, the client device 1021 presents the web page 302 to the user, including any optimized components 306A-306D. In particular, in the example web page 302, the minimized version 500B of the component 306A may be used in place of the full-sized version 500A of the component 306A to reduce overhead associated with processing elements of the full-sized version 500A of the component 306A (e.g., client device 1021 and web server 104 processing resources) and/or network resources in transmitting the full-sized version 500A of the component 306A. As noted above, in some implementations, the minimized version 500B of the component 306A may be expanded/replaced with the full-sized version 500A of the component 306A while the web page 302 is in use by the user (e.g., after the user clicks on the component 306A).

At operation 220, the web server 104, and in particular the component optimizer 110 of the web page generator 108, may continue to monitor usage characteristics of the user in relation to the web page 302 and/or components 306A-306D of the web page 302. In some implementations, the web server 104 may also monitor performance metrics in relation to the client device 1021, the network 106, and the web server 104 in relation to the web page 302 and the components 306A-306D of the web page 302. In this fashion, the web server 104 may maintain usage characteristics and performance metrics for subsequent web page 302 requests.

As described above, via the method 200, the web server 104 may intelligently configure components of web pages based on (1) usage characteristics of the users client devices 102₁-102_{N} in relation to each component on the web pages and (2) performance metrics associated with each web page (e.g., client device metrics for loading the web page on the client device 102₁-102_{N}, network metrics for fulfilling data requests for components in the web page over the network 106, and web server metrics for generating/serving the web page by the web server 104) to efficiently utilize network and processing resources. In particular, based on usage characteristics of the users and/or performance metrics associated with each web page, the web server 104 may dynamically load minimized versions of web page components to reduce resource consumption when these components are determined to have low user engagement/use and/or using a minimized version would produce a significant decrease in processing and/or network resource consumption.

One or more parts of the above implementations may include software and/or a combination of software and hardware. An electronic device (also referred to as a computing device, computer, etc.) includes hardware and software, such as a set of one or more processors coupled to one or more machine-readable storage media (e.g., magnetic disks, optical disks, read only memory (ROM), Flash memory, phase change memory, solid state drives (SSDs)) to store code (which is composed of software instructions and which is sometimes referred to as computer program code or a computer program) for execution on the set of processors and/or to store data. For instance, an electronic device may include non-volatile memory (with slower read/write times, e.g., magnetic disks, optical disks, read only memory (ROM), Flash memory, phase change memory, SSDs) and volatile memory (e.g., dynamic random access memory (DRAM), static random access memory (SRAM)), where the non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device is turned off, and that has sufficiently fast read/write times such that, rather than copying the part of the code/data to be executed into volatile memory, the code/data may be provided directly to the set of processors (e.g., loaded into a cache of the set of processors); in other words, this non-volatile memory operates as both long term storage and main memory, and thus the electronic device may have no or only a small amount of volatile memory for main memory. In addition to storing code and/or data on machine-readable storage media, typical electronic devices can transmit code and/or data over one or more machine-readable transmission media (also called a carrier) (e.g., electrical, optical, radio, acoustical or other form of propagated signals—such as carrier waves, infrared signals). For instance, typical electronic devices also include a set of one or more physical network interface(s) to establish network connections (to transmit and/or receive code and/or data using propagating signals) with other electronic devices. Thus, an electronic device may store and transmit (internally and/or with other electronic devices over a network) code and/or data with one or more machine-readable media (also referred to as computer-readable media).

Electronic devices are used for a variety of purposes. For example, an electronic device (sometimes referred to as a server electronic device) may execute code that cause it to operate as one or more servers used to provide a service to another electronic device(s) (sometimes referred to as a client electronic device, a client computing device, or a client device) that executes client software (sometimes referred to as client code or an end user client) to communicate with the service. The server and client electronic devices may be operated by users respectively in the roles of administrator (also known as an administrative user) and end user.

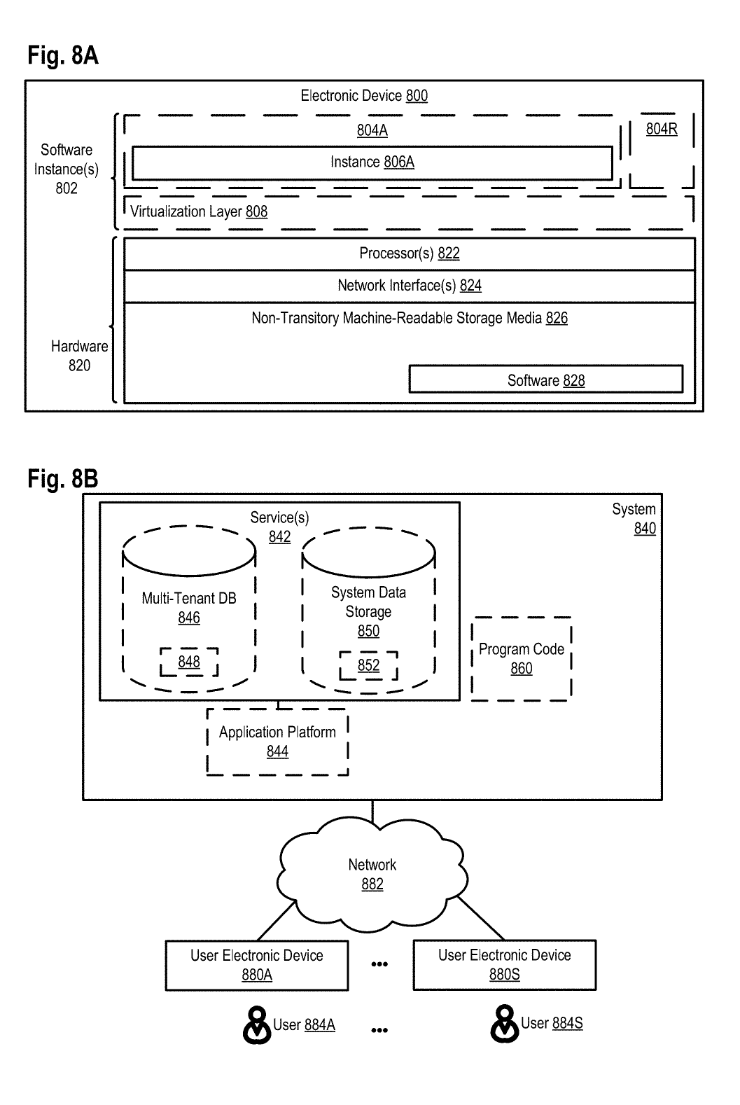

FIG. 8A is a block diagram illustrating an electronic device 800 according to some example implementations. FIG. 8A includes hardware 820 comprising a set of one or more processor(s) 822, a set of one or more network interfaces 824 (wireless and/or wired), and non-transitory machine-readable storage media 826 having stored therein software 828 (which includes instructions executable by the set of one or more processor(s) 822). Each of the previously described web browsers and the web page generator 108 may be implemented in one or more electronic devices 800. In one implementation: 1) each of the web browsers is implemented in a separate one of the electronic devices 800 (e.g., in client devices 102 operated by users where the software 828 represents the software to implement web browsers to interface with the web page generator 108); 2) the web page generator 108 is implemented in a separate set of one or more of the electronic devices 800 (e.g., a set of one or more server electronic devices where the software 828 represents the software to implement the web page generator 108); and 3) in operation, the electronic devices implementing the web browsers and the web page generator 108 would be communicatively coupled (e.g., by a network) and would establish between them (or through one or more other layers) connections for submitting web page requests to the web page generator 108 and returning a set of filed representing a web page to the web browsers. Other configurations of electronic devices may be used in other implementations (e.g., an implementation in which the web browser and the web page generator 108 are implemented on a single electronic device 800).

In electronic devices that use compute virtualization, the set of one or more processor(s) 822 typically execute software to instantiate a virtualization layer 808 and software container(s) 804A-R (e.g., with operating system-level virtualization, the virtualization layer 808 represents the kernel of an operating system (or a shim executing on a base operating system) that allows for the creation of multiple software containers 804A-R (representing separate user space instances and also called virtualization engines, virtual private servers, or jails) that may each be used to execute a set of one or more applications; with full virtualization, the virtualization layer 808 represents a hypervisor (sometimes referred to as a virtual machine monitor (VMM)) or a hypervisor executing on top of a host operating system, and the software containers 804A-R each represent a tightly isolated form of a software container called a virtual machine that is run by the hypervisor and may include a guest operating system; with para-virtualization, an operating system or application running with a virtual machine may be aware of the presence of virtualization for optimization purposes). Again, in electronic devices where compute virtualization is used, during operation an instance of the software 828 (illustrated as instance 806A) is executed within the software container 804A on the virtualization layer 808. In electronic devices where compute virtualization is not used, the instance 806A on top of a host operating system is executed on the “bare metal” electronic device 800. The instantiation of the instance 806A, as well as the virtualization layer 808 and software containers 804A-R if implemented, are collectively referred to as software instance(s) 802.

Alternative implementations of an electronic device may have numerous variations from that described above. For example, customized hardware and/or accelerators might also be used in an electronic device.

A network device (ND) is an electronic device that communicatively interconnects other electronic devices on the network (e.g., other network devices, user electronic devices, server electronic devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

FIG. 8B is a block diagram of an environment where the computing environment 100 may be deployed, according to some implementations. A system 840 includes hardware (a set of one or more electronic devices) and software to provide service(s) 842, including the web page generator 108. The system 840 is coupled to user electronic devices 880A-S over a network 882. The service(s) 842 may be on-demand services that are made available to one or more of the users 884A-S working for one or more other organizations (sometimes referred to as outside users) so that those organizations do not need to necessarily be concerned with building and/or maintaining a system, but instead makes use of the service(s) 842 when needed (e.g., on the demand of the users 884A-S). The service(s) 842 may communication with each other and/or with one or more of the user electronic devices 880A-S via one or more Application Programming Interface(s) (APIs) (e.g., a Representational State Transfer (REST) API). The user electronic devices 880A-S are operated by users 884A-S.

In one implementation, the system 840 is a multi-tenant cloud computing architecture supporting multiple services, such as a customer relationship management (CRM) service (e.g., Sales Cloud by salesforce.com, Inc.), a contracts/proposals/quotes service (e.g., Salesforce CPQ by salesforce.com, Inc.), a customer support service (e.g., Service Cloud and Field Service Lightning by salesforce.com, Inc.), a marketing service (e.g., Marketing Cloud, Salesforce DMP, and Pardot by salesforce.com, Inc.), a commerce service (e.g., Commerce Cloud Digital, Commerce Cloud Order Management, and Commerce Cloud Store by salesforce.com, Inc.), communication with external business data sources (e.g., Salesforce Connect by salesforce.com, Inc.), a productivity service (e.g., Quip by salesforce.com, Inc.), database as a service (e.g., Database.com™ by salesforce.com, Inc.), Data as a Service (DAAS) (e.g., Data.com by salesforce.com, Inc.), Platform as a Service (PAAS) (e.g., execution runtime and application (app) development tools; such as, Heroku™ Enterprise, Thunder, and Force.com® and Lightning by salesforce.com, Inc.), an analytics service (e.g., Einstein Analytics, Sales Analytics, and/or Service Analytics by salesforce.com, Inc.), a community service (e.g., Community Cloud and Chatter by salesforce.com, Inc.), an Internet of Things (IoT) service (e.g., Salesforce IoT and IoT Cloud by salesforce.com, Inc.), industry specific services (e.g., Financial Services Cloud and Health Cloud by salesforce.com, Inc.), and/or Infrastructure as a Service (IAAS) (e.g., virtual machines, servers, and/or storage). For example, system 840 may include an application platform 844 that enables PAAS for creating, managing, and executing one or more applications developed by the provider of the application platform 844, users accessing the system 840 via one or more of user electronic devices 880A-S, or third-party application developers accessing the system 840 via one or more of user electronic devices 880A-S.

In some implementations, one or more of the service(s) 842 may utilize one or more multi-tenant databases 846 for tenant data 848, as well as system data storage 850 for system data 852 accessible to system 840. In certain implementations, the system 840 includes a set of one or more servers that are running on server electronic devices and that are configured to handle requests for any authorized user associated with any tenant (there is no server affinity for a user and/or tenant to a specific server). The user electronic device 880A-S communicate with the server(s) of system 840 to request and update tenant-level data and system-level data hosted by system 840, and in response the system 840 (e.g., one or more servers in system 840) automatically may generate one or more Structured Query Language (SQL) statements (e.g., one or more SQL queries) that are designed to access the desired information from the one or more multi-tenant database 846 and/or system data storage 850.

In some implementations, the service(s) 842 are implemented using virtual applications dynamically created at run time responsive to queries from the user electronic devices 880A-S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 860 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 844 includes an application setup mechanism that supports application developers' creation and management of applications, which may be saved as metadata by save routines. Invocations to such applications, including the web page generator 108, may be coded using Procedural Language/Structured Object Query Language (PL/SOQL) that provides a programming language style interface. A detailed description of some PL/SOQL language implementations is discussed in U.S. Pat. No. 7,730,478 entitled, METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007. Invocations to applications may be detected by one or more system processes, which manages retrieving application metadata for the tenant making the invocation and executing the metadata as an application in a software container (e.g., a virtual machine).

Network 882 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, or similar wired and/or wireless protocols, and may include one or more intermediary devices for routing data between the system 840 and the user electronic devices 880A-S.

Each user electronic device 880A-S (such as a desktop personal computer, workstation, laptop, Personal Digital Assistant (PDA), smart phone, etc.) typically includes one or more user interface devices, such as a keyboard, a mouse, a trackball, a touch pad, a touch screen, a pen or the like, for interacting with a graphical user interface (GUI) provided on a display (e.g., a monitor screen, a liquid crystal display (LCD), etc.) in conjunction with pages, forms, applications and other information provided by system 840. For example, the user interface device can be used to access data and applications hosted by system 840, and to perform searches on stored data, and otherwise allow a user 884 to interact with various GUI pages that may be presented to a user 884. User electronic devices 880A-S might communicate with system 840 using TCP/IP (Transfer Control Protocol and Internet Protocol) and, at a higher network level, use other networking protocols to communicate, such as Hypertext Transfer Protocol (HTTP), FTP, Andrew File System (AFS), Wireless Application Protocol (WAP), File Transfer Protocol (FTP), Network File System (NFS), an application program interface (API) based upon protocols such as Simple Object Access Protocol (SOAP), Representational State Transfer (REST), etc. In an example where HTTP is used, one or more user electronic devices 880A-S might include an HTTP client, commonly referred to as a “browser,” for sending and receiving HTTP messages to and from server(s) of system 840, thus allowing users 884 of the user electronic device 880A-S to access, process and view information, pages and applications available to it from system 840 over network 882.

In the above description, numerous specific details such as resource partitioning/sharing/duplication implementations, types and interrelationships of system components, and logic partitioning/integration choices are set forth in order to provide a more thorough understanding. It will be appreciated, however, by one skilled in the art, that the invention may be practiced without such specific details. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

In the following description and claims, the term “coupled,” along with its derivatives, may be used. “Coupled” is used to indicate that two or more elements, which may or may not be in direct physical or electrical contact with each other, co-operate or interact with each other.

The operations in the flow diagrams are be described with reference to the exemplary implementations in the other figures. However, the operations of the flow diagrams can be performed by implementations other than those discussed with reference to the other figures, and the implementations discussed with reference to these other figures can perform operations different than those discussed with reference to the flow diagrams.

While the flow diagrams in the figures show a particular order of operations performed by certain implementations, it should be understood that such order is exemplary (e.g., alternative implementations may perform the operations in a different order, combine certain operations, overlap certain operations, etc.).

While the above description includes several exemplary implementations, those skilled in the art will recognize that the invention is not limited to the implementations described and can be practiced with modification and alteration within the spirit and scope of the appended claims. The description is thus illustrative instead of limiting.

What is claimed is:

1. A method for dynamically configuring a web page of an application, including a set of components presented in the web page, the method comprising:
determining, by a web server, usage characteristics associated with a user and the set of components of the web page;
modifying, by the web server, an optimization parameter for a component in the set of components based on the usage characteristics, wherein the optimization parameter for the component indicates that a minimized version of the component is to be used in the web page for the user instead of a full-sized version of the component; and
generating, by the web server based on the optimization parameter for the component, the web page such that the minimized version of the component is used in the web page.

2. The method of claim 1, wherein the usage characteristics indicate previous levels of engagement of the user with the set of components, and
wherein the optimization parameter is modified to indicate that the minimized version of the component is to be used in the web page when the usage characteristics indicate a low engagement of the user with the component.

3. The method of claim 2, wherein the usage characteristics include one or more of (1) click interactions by the user in the web page during one or more previous sessions with the web page, (2) previous click paths by the user in the web page during the one or more previous sessions with the web page, and (3) previous time spent by the user with the web page during the one or more previous sessions on the web page.

4. The method of claim 3, wherein the usage characteristics further include one or more of (1) an engagement metric, which indicates the percentage of time each component was used by the user during the one or more previous sessions with the web page and (2) an engagement rate metric, which indicates a rate of change of use between the one or more previous sessions with the web page.

5. The method of claim 1, further comprising:
determining, by the web server, performance metrics per component of the set of components,
wherein the performance metrics indicate processing and network resources used to generate and load the web page using both the full-sized version of the component and the minimized version of the component, and
wherein the modifying the optimization parameter is further based on the performance metrics.

6. The method of claim 5, wherein the optimization parameter is modified to indicate that the minimized version of the component is to be used in the web page when the performance metrics indicate a difference in performance between the full-sized version of the component and the minimized version of the component above a threshold.

7. The method of claim 1, wherein the minimized version of the component includes fewer display elements than the full-sized version of the component.

8. A non-transitory machine-readable medium that stores instructions, which when executed by a web server, cause the web server to:
determine usage characteristics associated with a user and a set of components of a web page;
modify an optimization parameter for a component in the set of components based on the usage characteristics, wherein the optimization parameter for the component indicates that a minimized version of the component is to be used in the web page for the user instead of a full-sized version of the component; and
generate, based on the optimization parameter for the component, the web page such that the minimized version of the component is used in the web page.

9. The non-transitory machine-readable medium of claim 8, wherein the usage characteristics indicate previous levels of engagement of the user with the set of components, and
wherein the optimization parameter is modified to indicate that the minimized version of the component is to be used in the web page when the usage characteristics indicate a low engagement of the user with the component.

10. The non-transitory machine-readable medium of claim 9, wherein the usage characteristics include one or more of (1) click interactions by the user in the web page during one or more previous sessions with the web page, (2) previous click paths by the user in the web page during the one or more previous sessions with the web page, and (3) previous time spent by the user on the web page during the one or more previous sessions with the web page.

11. The non-transitory machine-readable medium of claim 10, wherein the usage characteristics further include one or more of (1) an engagement metric, which indicates the percentage of time each component was used by the user during the one or more previous sessions with the web page and (2) an engagement rate metric, which indicates a rate of change of use between the one or more previous sessions with the web page.

12. The non-transitory machine-readable medium of claim 8, wherein the instructions further cause the web server to:
determine performance metrics per component of the set of components,
wherein the performance metrics indicate processing and network resources used to generate and load the web page using both the full-sized version of the component and the minimized version of the component, and
wherein the modifying the optimization parameter is further based on the performance metrics.

13. The non-transitory machine-readable medium of claim 12, wherein the optimization parameter is modified to indicate that the minimized version of the component is to be used in the web page when the performance metrics indicate a difference in performance between the full-sized version of the component and the minimized version of the component above a threshold.

14. The non-transitory machine-readable medium of claim 8, wherein the minimized version of the component includes fewer display elements than the full-sized version of the component.

15. A web server for dynamically configuring a web page of an application, including a set of components presented in the web page, the web server comprising:
a component optimizer to determine usage characteristics associated with a user and a set of components of a web page and modify an optimization parameter for a component in the set of components based on the usage characteristics, wherein the optimization parameter for the component indicates that a minimized version of the component is to be used in the web page for the user instead of a full-sized version of the component; and
a web page generator to generate, based on the optimization parameter for the component, the web page such that the minimized version of the component is used in the web page.

16. The web server of claim 15, wherein the usage characteristics indicate previous levels of engagement of the user with the set of components, and
wherein the optimization parameter is modified to indicate that the minimized version of the component is to be used in the web page when the usage characteristics indicate a low engagement of the user with the component.

17. The web server of claim 16, wherein the usage characteristics include one or more of (1) click interactions by the user in the web page during one or more previous sessions with the web page, (2) previous click paths by the user in the web page during the one or more previous sessions with the web page, and (3) previous time spent by the user on the web page during the one or more previous sessions with the web page.

18. The web server of claim 17, wherein the usage characteristics further include one or more of (1) an engagement metric, which indicates the percentage of time each component was used by the user during the one or more previous sessions with the web page and (2) an engagement rate metric, which indicates a rate of change of use between the one or more previous sessions with the web page.

19. The web server of claim 15, wherein the component optimizer to further:
determine performance metrics per component of the set of components,
wherein the performance metrics indicate processing and network resources used to generate and load the web page using both the full-sized version of the component and the minimized version of the component, and
wherein the modifying the optimization parameter is further based on the performance metrics.

20. The web server of claim 19, wherein the optimization parameter is modified to indicate that the minimized version of the component is to be used in the web page when the performance metrics indicate a difference in performance between the full-sized version of the component and the minimized version of the component above a threshold.
